(19) United States
(12) Patent Application Publication
(10) Pub. No.: US 2009/0077229 A1
(43) Pub. Date: Mar. 19, 2009

(54) PROCEDURES AND MODELS FOR DATA COLLECTION AND EVENT REPORTING ON REMOTE DEVICES AND THE CONFIGURATION THEREOF

(76) Inventor: Kenneth Ebbs, Los Altos, CA (US)

Correspondence Address: TRAN & ASSOCIATES, 6768 MEADOW VISTA CT., SAN JOSE, CA, 95135, US

(21) Appl. No.: 12/039,764

(22) Filed: Feb. 29, 2008

Related U.S. Application Data
(60) Provisional application No. 60/893,891, filed on Mar. 9, 2007.

(51) Int. Cl. G06F 15/173

(52) U.S. Cl. 709/224

(57) ABSTRACT

Systems and methods are disclosed to monitoring a remote object with a remote client to receive a configuration file directing the remote client to capture events of interest specified by one or more rules; a wireless network to communicate events of interest captured by the remote client; and a server coupled to the remote client over the wireless network, the server receiving events of interest from the remote client and generating a report on the events of interest.

This application claims priority to Provisional Application Ser. No. 60/893,891 filed Mar. 9, 2007, the content of which is incorporated by reference.

### BACKGROUND

Several commercial devices provide vehicle monitoring capability. One example is the Alltrackusa product that relies on a global positioning satellite (GPS) system to track vehicle operation. Such systems employ a calculating methodology to determine speed and acceleration by using the position differential implied by the GPS. Conversely, Davis Technologies markets the CarChip product which is a passive OBDII data recorder for hobbyists and car enthusiasts who want to record their engine performance. The shortcomings of the Alltrackusa “GPS only” application is that actual speed information is not available during intermittent losses of the GPS signal, which are frequent. This limits the product's usefulness for creating a complete dataset suitable for developing a useful and objective set of driver safety ratings. The shortcoming of the CarChip product is that the unit does not provide GPS capability and the target market is for car enthusiasts who want to monitor engine diagnostics.

U.S. Pat. No. 6,064,970 discloses a method and system for determining the cost of automobile insurance based upon monitoring, recording and communicating data representative of operator and vehicle driving characteristics. The system includes use of a wireless up-link to a central control station to communicate “triggering events”.

U.S. Pat. No. 6,064,970 defines a methodology for private insurance quotes based on endogenous driver variables that are acquired from the customer or collected by the insurance company. U.S. Pat. No. 6,064,970 does not teach an apparatus and business process that allows customers to voluntarily create datasets that are then objectively interpreted by a third party and converted to objective safety ratings, much as credit payments or delinquencies are converted to an objective credit rating, or company debt histories converted to a bond rating. This distinction is vital in order to promote the adoption of driver monitoring technology and guarantee that it is utilized in a manner that promotes the most societal good, rather than simply being the exclusive purview of one company's insurance premium pricing structure.

U.S. Pat. No. 6,931,309 discloses the uploading, evaluation and storing of recorded date and time stamped operating data (“time marked data”) from a motor vehicle component and the subsequent upload to a CPU or central web-server for objective analysis. The data may also be location marked and thereby allow the vehicle data to be correlated with separate time or location specific databases. The recording of the data to a separate device can in such a manner as to insure a complete dataset, minimize fraudulent use, and thus insure the accuracy and usefulness of said data to third parties. Utilization of the data may be subject to terms of agreements among the vehicle operator, the vehicle owner, insurance companies and underwriters (health, life or auto, etc.), research professionals, marketing and advertising firms, legal representatives, governmental authorities or other institutions. However, the system discussed in the '309 patent sends data continuously, thus wasting bandwidth and energy.

### SUMMARY

Systems and methods are disclosed to monitoring a remote object with a remote client to receive a configuration file directing the remote client to capture events of interest specified by one or more rules; a wireless network to communicate events of interest captured by the remote client; and a server coupled to the remote client over the wireless network, the server receiving events of interest from the remote client and generating a report on the events of interest.

Implementations of the above aspect can include one or more of the following. The remote client can be a mobile device, a cell phone, a personal digital assistant or a black box installed in a vehicle. The event of interest can be vehicle speed, vehicle performance data, vehicle diagnostic data, or vehicle maintenance data. The server generates and publishes the configuration file to all remote clients. The remote client downloads one or more dynamically pluggable modules loaded at startup time and specified by the configuration file. A set of modules can be provided on a remote client to be changed without physical access to the remote client. A triggered event can be specified in the configuration file. The triggered event can be an expression stored in postfix form indicating one or more conditions in which the event will be generated by the remote client. The triggered event can also be a reporting rate indicating a maximum rate for event transmission. The triggered event can also be a sampling rate or a sampling window.

Advantages of the preferred embodiments of the Event Broker may include one or more of the following:
The system exposes a generic flexible model applicable to any device and not limited to events of a specific nature making it adaptable to any business or personal scenario. It eliminates the need to write custom code specific to a particular device or scenario. Consider an alternate solution where rules and monitoring are built directly into the software running on the device.
Once installed, the system can be managed, administered, upgraded, remotely from the Server. In addition to rules, new functionality (or code) can be installed on the Device without ever having the Device in hand. This is critical in situations where the Device is hard to get a hold of (e.g. when it is bolted into a vehicle).
The Event Broker Client can process potentially hundreds if not thousands of Events simultaneously efficiently without over burdening the device.
The system sends data only upon certain conditions, thus saving wireless bandwidth is wasted. Additionally, the system dynamically changes what data to be retrieved or when the data should be sent.

### BRIEF DESCRIPTION OF THE DRAWINGS

FIG. 1 shows an exemplary network with a server and one or more remote devices.

FIG. 2 shows an exemplary process supported by an Event Broker.

FIG. 3 shows exemplary configuration files and modules supported by the remote client.

FIG. 4 shows an exemplary process for updating modules on the remote client.

FIG. 5 shows an exemplary process for evaluating expressions in the modules.

FIG. 6 shows an exemplary process for real-time adjustment of sampling rates for processes (PIDs) running on the remote client.

FIG. 7 shows an exemplary process for handling triggered events.

FIG. 8 shows an exemplary wireless network with a server and one or more remote devices, some of which have intermittent access to the wireless network.

FIG. 9 shows an exemplary communication process over the wireless network.

FIG. 10 shows an exemplary communication process over a local channel.

### DESCRIPTION

The system described herein provides a set of procedures and methods known as the Event Broker which facilitate the monitoring of arbitrary remote devices and the configuration of the monitored information providing the ability to configure and collect values on the remote device and the ability to be alerted when an event of interest occurs on the device. The Event Broker exposes a generic model applicable to any device and not limited to events of a specific nature and exposes processes for efficiently collecting data to be monitored and for generating events based on this monitored data. In addition, the Event Broker provides facilities for remotely and automatically updating what data is monitored as well as what events are reported without an administrator having physical access to the device.

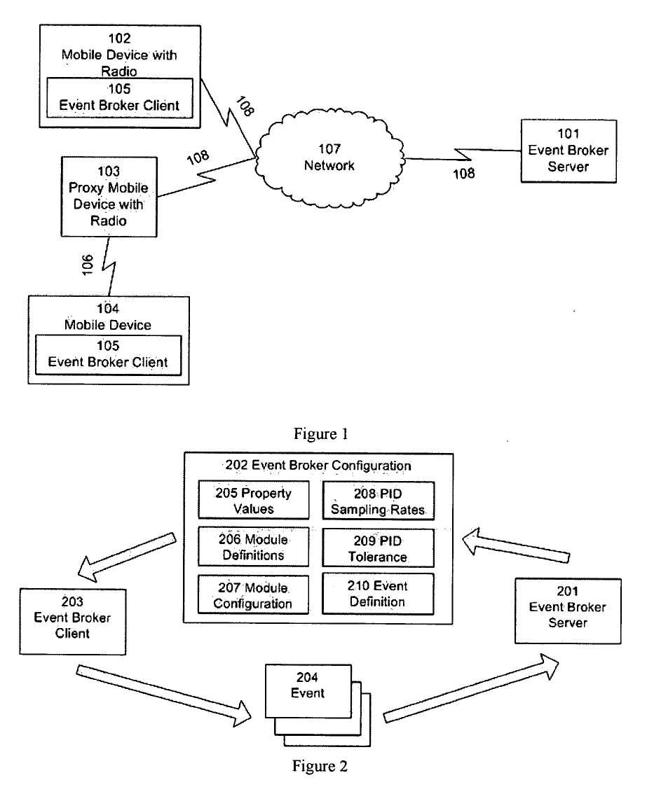

FIG. 1 gives a high level overview of the Event Broker system. We begin with the Remote Devices 104 and 102 on which the Event Broker Client 105 is installed. These Devices have a Connection 108 to the Event Broker Server 101 via the Network 107. While the Connection 108 is typically via a wireless network, the Network 107 for purposes of this system can be considered anything capable of carrying data including but not limited to the Internet, a wireless network, and a satellite network. The Event Broker Client typically runs on a wireless remote device such as a mobile phone or PDA, but can also run on any “networked” device (e.g. a personal computer) capable of connecting to the Network 107 or capable of connecting to a networked device via a Direct Connection 106. FIG. 1 depicts the two general classes of devices which may host the Event Broker Client 105.
Remote Device With Radio 102 indicates a Device capable of connecting to the Network 107. This device may have a way to interact with the user (e.g. a screen or keyboard) or it may be a stand alone self-contained unit. The Event Broker Client runs in the background and does not require intervention on behalf of the user on the device.
104, Remote Device indicates a device which cannot connect to the internet, an instead must rely on 103, a Proxy Device, for all network connectivity. 103 and 104 are connected occasionally via a local communications link 105 typically but not limited to Bluetooth or a serial cable. This configuration can reduce cost significantly in that it requires on a single network data plan. For example, user's with existing wireless PDA devices can use these to proxy Event Broker Client events from a Device such a GPS Black Box with Bluetooth mounted in a vehicle.

In one embodiment, the Event Broker has two components, a Client component running on a Remote Device such as a cell phone, PDA, or black box installed in a vehicle, and a Server component capable of servicing any number of these Remote Devices. The Server is responsible for providing a Configuration to the Client, and upon receipt of the Configuration, the Client sends Events of interest (as defined in the Configuration) back to the Server. This provides a generic framework for data collection and monitoring Remote Devices with the ability to generate rule based Events sent to a centralized source (the Server).

Next, a simplified example is discussed to clarify the basic functions of the Event Broker. The exemplary system manages hundreds of vehicles and is interested in being notified when one of the vehicles is speeding. These vehicles have installed in them a wireless Remote Device with the ability to detect the speed of the vehicle. The Event Broker Client software is installed on these remote devices and the company has installed the Event Broker server. The steps involved include:
The administrator logs into the Event Broker Server using a web browser. Here they see the company's vehicles.
The administrator defines a Configuration containing a single Event triggered by “($SPEED_KPH/1.603944)>75”. When the speed in MPH of any vehicle exceeds 75 MPH, the Event will be generated.
The administrator publishes this Configuration to all devices.
The Event Broker Clients running in the vehicles receive the Configuration containing the new Event. The driver of the vehicle is unaware that anything has happened. Upon receiving the new Event, the Event Broker Client on each of the vehicles begins to monitor the speed. As soon as the vehicle exceeds 75 MPH, the Event Broker Client sends an Event back to the Event Broker Server.
The Event Broker Server stores all Events in the database. The company administrator logs into the Server periodically and runs a report to find out who has been speeding for the day.
Because the Event Broker Client is capable of collecting other data other than speed (such as engine coolant temperature), the administrator can define other events. For example, s/he could define an Event “$COOLANT_TEMP>120” to be notified (possibly over email) when a vehicle is “too hot”.

The advantages of the preferred embodiments of the Event Broker can include:
The Event Broker exposes a generic flexible model applicable to any device and not limited to events of a specific nature making it adaptable to any business or personal scenario. It eliminates the need to write custom code specific to a particular device or scenario. Consider an alternate solution where rules and monitoring are built directly into the software running on the device.
Once installed, the Event Broker can be managed, administered, upgraded, remotely from the Server. In addition to rules, new functionality (or code) can be installed on the Device without ever having the Device in hand. This is critical in situations where the Device is hard to get a hold of (e.g. when it is bolted into a vehicle).
The Event Broker Client can process potentially hundreds if not thousands of Events simultaneously efficiently without over burdening the device.

As Depicted in FIG. 2, The Event Broker Server 201 can define a new or edit an existing Event Broker Configuration 202. Once defined or edited, a Configuration is pushed to one or more Event Broker Clients 203 each running on a Remote Device. Once the Device receives the Configuration 202 it will emit a stream of Events 204 as defined in the Configuration each of which sent back to the Event Broker Server where they can be acted on in a number of ways. This Configuration is all done remotely so that the administrator need never have the Devices in hand, and furthermore, an Event Broker Client's Configuration can be altered at any time.

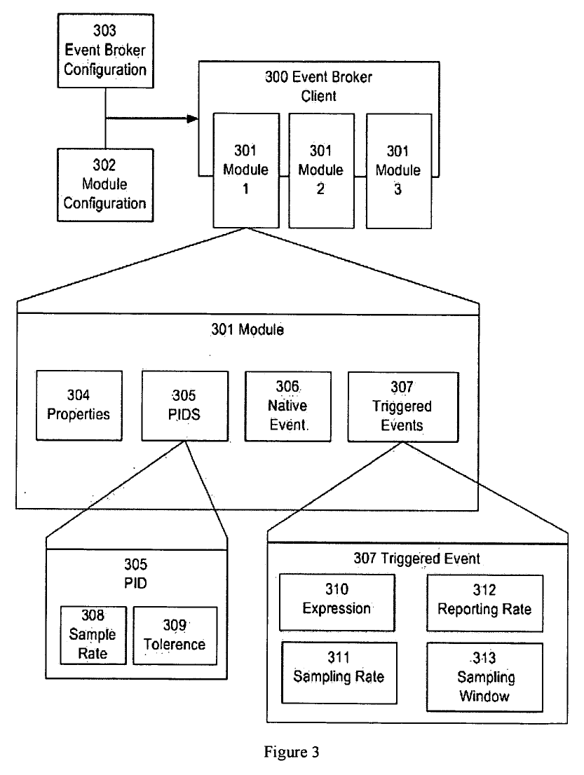

FIG. 3 shows the Event Broker Client, 300 which consists of any number of dynamically pluggable Modules 301 loaded at startup time and specified in the Module Configuration File 302. The ramification is that the Event Broker Server in a Configuration can download a set of Modules and a Module Configuration 303 to a Remote Device where they are saved, thus allowing the set of Modules on a Device to be changed without having to have physical access to the device. This is powerful since the Event Broker Client with potentially no modules can be provisioned onto the Device when the Device is physically in hand; thereafter, all Modules and configuration of the Modules is done remotely. This is a differentiating factor in environments such as transportation where the Devices are physically wired and mounted into vehicles and physical access to the Devices happens only when the Devices are initially installed or need to be replaced.

FIG. 3 also shows the entities that make up a Module 301, namely Properties 304, PIDs or parameter IDs 305, Events 306, and Triggered Events 307 where Triggered Events are a special class of dynamically created Event. Properties 304 are named entities exposed by a Module as a means of configuring the Module and assigned Property Values (FIG. 2, 205) as part of an Event Broker Configuration (FIG. 2, 202). Take as an example a Device with an accelerometer capable of measuring acceleration along a horizontal axis and generating an Event when the acceleration on this axis exceeds a certain threshold value. This threshold value would be exposed by the accelerometer Module as a Property thus allowing the threshold value to set in a Configuration defined in the Event Broker Server.

A PID 305 is a named entity whose value is sampled periodically at a rate defined by the Sampling Rate 308 by the Module running in the Event Broker Client and whose value can be queried at any time by the Event Broker Server. Examples of PIDs are latitude, longitude, speed, odometer, temperature, acceleration, day of the week, version number, and just about any other singular value which can be collected on the Remote Device. An Event Broker Client typically contains many Modules, each in turn containing many PIDs, and the Client must ensure that the Device's CPU is not overwhelmed as a result of sampling PIDs. By allowing the Sampling Rate (FIG. 2, 208) of a particular PID to be set and dynamically provisioned in the Event Broker Configuration (FIG. 2, 202), the Event Broker Client can ensure that less powerful devices can be configured with lower Sampling Rates. In addition to a Sampling Rate, a PID has a Tolerance 309, indicating the amount the PID's value must change before it is considered “changed”. This will be described later when Event generation is discussed.

An Event (FIG. 2, 204) signifies an event of interest and is generated by the Event Broker Client running in the Remote Device and sent to the Event Broker Server over the Network. Back to FIG. 3, a Native Event 306 is pre-defined by the Module; whereas a Triggered Event 307 is defined by a Rule Set 307 present in the Configuration meaning that Triggered Events can be dynamically defined on the fly. An Event carries data with it in the form of one or more PID values, each Event with different PIDs once again defined in the Configuration.

The model described can be applied to any Device and any can be used to describe collection and reporting of arbitrary data as well as generation of alerts, warnings, monitoring conditions, etc. all in the form of Events. This allows the Event Broker to adapt easily and dynamically to changing business needs.

Before describing the Triggered Event Rule Set 307, it is useful to describe the means by which a Configuration is applied to the Event Broker Client and the means in which Modules can be dynamically loaded. Back to FIG. 2, an Event Broker Configuration 202 defined on the Event Broker Server consists of one or more of the following:
Property Values 205—values for one or more properties defined by the Modules
PID Sampling Rates 208—sampling rates for a Modules PIDs
PID Tolerances 209—tolerances for PIDs
Event Definitions 210—a set of compiled Rules defining Triggered Events
Event Broker Modules—a Module Configuration 207 containing the list of Module Definitions 206 to load and the version of each module. The Module Definitions themselves are code (e.g. DLL's or Java JAR files) and are embedded directly in the configuration as binary data.

Once a Configuration change is made, the Event Broker Server Administrator can push the Configuration to one or more Devices. In addition, a Device periodically (e.g. once a day) requests its Configuration from the Server. This is necessary so that new devices can be brought on line without manual intervention (i.e. without the Server administrator having to explicitly push the Configuration).

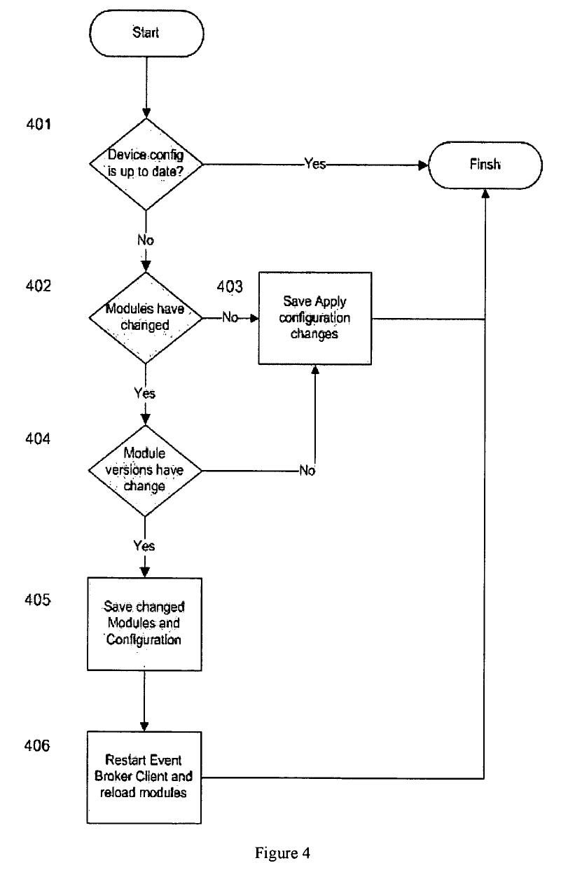

A Device processes its Configuration according to the process depicted in FIG. 4. A Configuration contains a timestamp and revision number assigned by the Server and used by the Event Broker Client to determine whether its Configuration is already up to date, 401. The Client uses this to ignore redundant Configuration requests. The Client then compares its list of Modules with that provided in the Configuration, 402 and 403. If the Module List contains, newly added Modules, new versions of existing Modules, or removed Modules, the Client must adjust it list of Modules accordingly, save the Configuration changes and then restart causing the new Module definitions and other Configuration changes to be applied as depicted in 405, 406; otherwise, in the absence of Module changes, the Client simply applies the changes specified in the Configuration, 403.

Triggered Events are defined in the Configuration and as such can be remotely downloaded to an Event Broker Client, thus allowing new Events to be defined on the fly as business needs change. Here are some examples of Triggered Events. The temperature in a refrigeration unit rises above freezing. The average speed of the vehicle exceeds 65 MPH. When a triggered Event occurs, the Event is sent to the Server where it can be acted upon in any number of ways including but not limited to: notifying the administrator by sending an email, SMS, pager notification, producing reports based on Events, etc. A Triggered Event (FIG. 3, 307) is defined by the following:
An Expression 310, stored in postfix form for efficient evaluation, indicating the conditions in which the Event will be generated by the Event Broker Client.
A Reporting Rate 312 indicating the maximum rate the Event Broker Client will send the Event. This value prevents the Client from flooding the server with the same Event too often.
A Sampling Rate 311 indicating how often the PIDS in the Triggered Event expression should be collected.
A Sampling Window 313 indicating the interval over which the PIDS in the Triggered Event expression should be averaged.
   The Triggered Event Expression is initially represented as a String and may contain operators including but not limited to + (plus), − (minus), ! (logical not), && (logical and), ∥ (logical or), * (multiply), / (divide), == (equal), != (not equal), > (greater than), < (less than), >= (greater than or equal), <= (less than or equal). The Expression will also contain operands including but not limited to strings and numeric values and also using parentheses to define precedence. In addition, any PID value can be referenced as an operand by preceding it with a ‘$’ character. As an example, assume that we have a PID named SPEED_KPH that collects the vehicle's speed in kilometers/hour. We could define an Event that was triggered when speed exceeded 75 MPH by the following expression: “($SPEED_KPH/1.603944)>75”. By setting an Event sampling rate of 10 seconds and a sampling window of 60 seconds, the value speed would be collected every 10 seconds and averaged over a 60 second window. Each Module can have pre-defined functions which can be referenced in the Expression by preceding the function name with the ‘%’ character and surrounding the argument list (which itself can contain PID references) with parentheses. Here are some examples: “% IsWeekDay( )”, “% TotalKilometersTravelled(“odometer1”)”. While there is nothing new about expressions in general, the ability for an Expression to reference a piece of sampled data on the client and to apply functions to it provides the flexibility needed by the Event Broker to define and generate arbitrary Events.

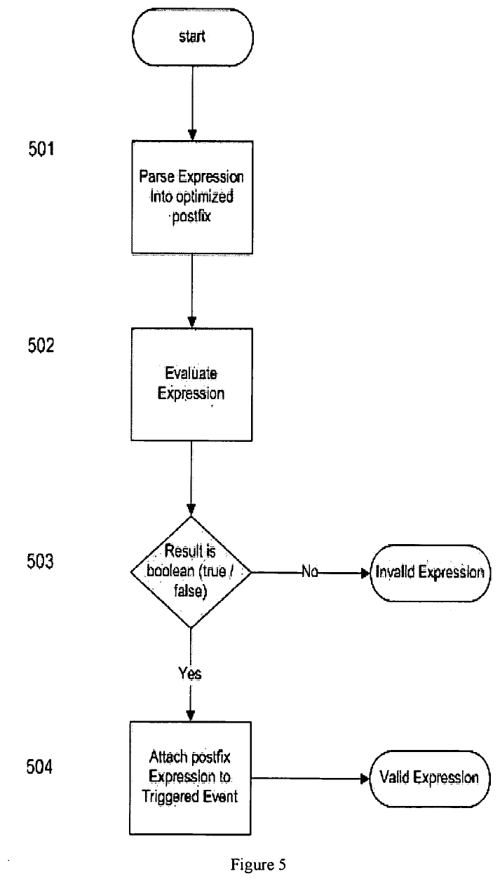

Turning now to FIG. 5, the Event Broker Client must be able to evaluate a Triggered Event Expression in a timely manner. In order to accommodate this, the Event Broker Server is responsible for parsing the Expression into an optimized postfix form 501 and must further validate the Expression to ensure it returns a Boolean result 502, 503. The postfix form can be efficiently evaluated by the Event Broker Client since it does not have to parse the expression and determine precedence of the operators.

One embodiment of the system ensures that the Event Broker Client does not saturate the Device, consuming too much CPU. We have seen how PID sampling rates can be adjusted in the Configuration. In addition, the Event Broker Client contains a mechanism for dynamically adjusting PID sampling rates as depicted in FIG. 5. Each Module wakes up at an interval equivalent to the smallest Sampling Rates of any of its PIDs 601 and collects and stores the values of all PIDs that need to be sampled at that particular time. The Module determines that a PID should be sampled by computing the amount of time since the PID was last sampled (i.e. Elapsed Time=Current Time−Last Sampled Time) 603. If Elapsed Time is greater than or equal to the PIDs Sampling Rate 604, then the PID's value is sampled and stored 605 and its Last Sampled Time is updated. If the Elapsed Time is “close” to the Sampling Rate 607, then we know that the system is behaving as expected and is not overloaded. If however, the Elapsed Time is far greater (e.g. two times) than the Sampling Rate 608, this indicates a condition in which the Event Broker Client is too busy to sample PIDS at their requested intervals. In this case, the PIDs Sampling Rate is increased “temporarily” 610. Since PIDs are likely to have similar Sampling Rates, it is expected that the Sampling Rates of a number of PIDs will be increased. This will reduce the overall load on the Event Broker, freeing up resources for the Event Broker Client itself or for other applications on the Device. In this way the sampling rate will be increased dynamically when load on the device is high. If the Elapsed Time is very close to the sampling rate 607, then we know that PIDs are being sampled in a timely manner and that we can reduce the sampling rate downwards towards its original value specified in the Configuration 609. By tuning the thresholds for increasing and decreasing the sampling rate, we can avoid thrashing. Typically, many of a Module's PIDs are sampled at the same interval, so that a further optimization can be realized by grouping PIDs with identical sampling intervals. This optimization allows the computation and Sampling Rate adjustment described above to be done on a group of PIDs as a whole rather than on each individual PID.

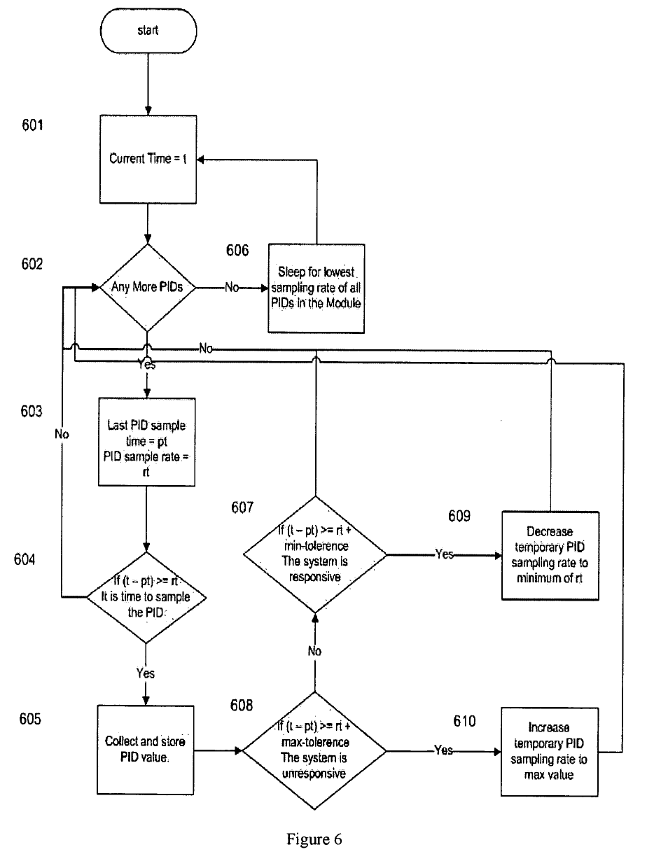

Another embodiment ensures that the Triggered Events are processed in a timely manner by the Event Broker Client. FIG. 6 depicts the process for processing an Event. Each Module wakes up at an interval equivalent to the smallest sampling rates of any of its PIDs and looks for Triggered Events whose expressions may need to be evaluated 701. For each such event, we track a Creation Time (i.e. the time the Client begins to collect data on behalf of the Event) as well as a Last Reported Time (i.e. the time the Client last generated the Event) 703. If the Current Time−Last Reported Time is smaller than the Event Report Rate 704, we can ignore the Event since it was recently generated. This check efficiently eliminates Events that are generated often but rarely reported. Next we compute the Elapsed Time=Current Time−Creation Time and if this Elapsed Time is equal to or exceeds the Sampling Rate 705, we store the PID values referenced in the Triggered Events Expression only if, “the PID's value has changed adequately and this is the first sample” 709. Note that we rely on the previously sampled PID value collected in the PID sampling process denoted by FIG. 4. This is important since there may be many rules referencing the same PID and since sampling a PID's value may be expensive (e.g. as is the case with GPS).

The meaning of 709, “the PID's value has changed adequately and this is the first sample” needs to be explained. The idea is that we do not want to collect PID data, average it, and evaluate a rule unless absolutely necessary, and that if a Triggered Event Expression previously evaluated to false, and if the PID's current value has not changed “enough” since the last sampling, then there is no way the change in the PID's value could trigger the Expression and hence can be ignored 708. If however, we have started sampling data for the Event, we must continue to do so, hence, “and this is the first sample”. The Event Broker Client looks at the last average value of the PID (i.e. its last average value when the Event's Expression was last evaluated) and the current sampled value of the PID and if the absolute value of the difference is greater than the PID's Tolerance, then it has “changed adequately” and we begin sampling.

An example will clarify: consider the Expression “$TEMP_DEGF>32”, which evaluates to true when temperature rises above freezing. The Tolerance of the TEMP_DEGF PID is 1 and the Sampling Rate of the rule is 5 seconds. When the Event Broker Client is started, it finds the temperature to be 28.5 and the Expression evaluates to False. It is not until the temperature rises to 29.5 or falls below 27.5 that the next Expression evaluation will occur. Now assume that the temperature rises suddenly to 31.9 and remains at 32.8 for a long time. In this case, the Event will go undetected until the temperature reaches 32.9 degrees, hence the use of the word “Tolerance”.

The system also provides an “Automatic Tolerance Computation” in which the PIDs Tolerance can be computed dynamically. This would typically apply to Expressions containing a few PIDs only (i.e. one or two) since beyond that the computation could be prohibitively expensive. Each PID specifies a valid range of values (i.e. a minimum and a maximum). When the result of evaluating an Expression returns false, the expression evaluator can re-evaluate the expression, iterating over the range of PID values in an increment specified by the PID's Tolerance until the result becomes true. This in effect produces the exact value of the PID needed to trigger the expression and this value can be used to compute the new Tolerance. The effect is that Expression PID sampling and rule evaluation will occur only when the PID's value reaches its exact point.

Using the previous temperature example as a starting point, the initial Expression evaluation finds the temperature at 28.5, and the TEMP_DEGF has a range of 0 . . . 99 and a Tolerance of 1. The initial Expression evaluation starts at 28.5 in increments of 1 and upon reaching 32.5, a value of true is returned. The new Tolerance can therefore be set to abs(32.5−28.5)=4 (where abs is the absolute value). The temperature will have to drop or rise by 4 degrees before the Expression will be evaluated again. Once an Event is generated, Tolerances are reset to their original values. Consider a similar expression “$TEMP_DEGF<32” with all else being the same as the previous examples. Here the initial Expression evaluation finds the temperature at 57, evaluating to false. We evaluate the expression starting at 57, increasing to 99 in increments of 1, and a result of true is never found. The Client begins again at 57 decrementing in increments of 1 down to 0, when at the value 31, the Expression evaluates to true. The new Tolerance now becomes abs(31−57)=26, and the temperature will either have to rise or drop by 26 degrees before the Expression will be evaluated.

“Automatic Tolerance Computation” can easily be performed on simple expressions involving a single PID only; however, as expression becomes more complicated the task involves more computation and examination of the postfix Expression itself. Consider “$TEMP_DEGF<32 ∥ $TEMP_{—DEGF>}50” or mile per gallon computation such as “$MILES₋DRIVEN/$GALLONS_USED”.

Returning to FIG. 6, after storing the PID's value 711, the Event Broker Client checks whether Elapsed Time is equal to or exceeds the Sampling Window 706. If so, the Expression can be evaluated 714 and result is true 713, an Event is generated 712.

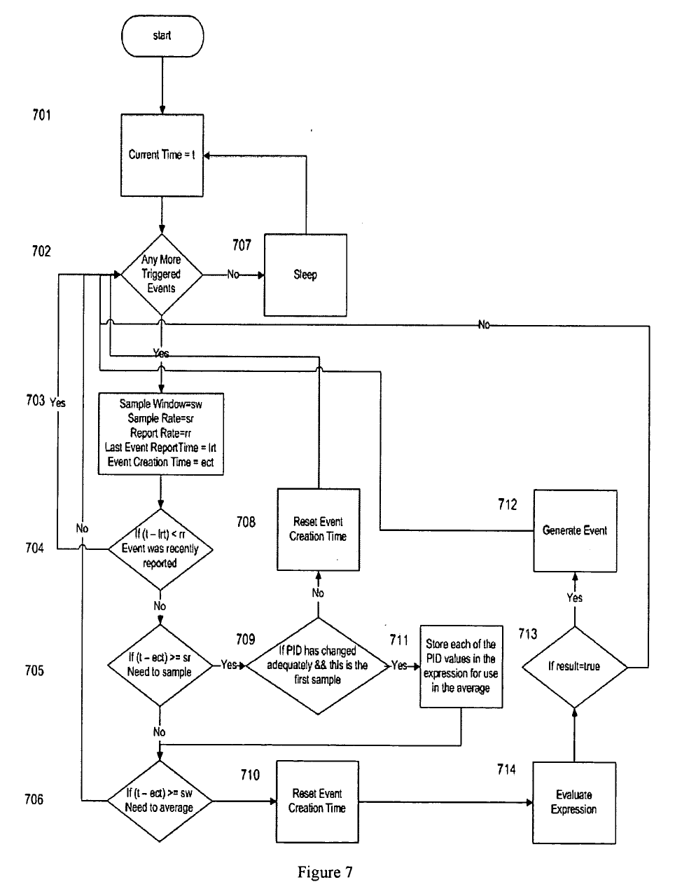

Yet another embodiment handles Event Priorities as follows. An Event (either Native or Triggered) is given a priority and that when the system becomes loaded, the Client services higher priority Events before lower priority Events. The priority of an Event gradually increases to avoid starvation. This slightly impacts the process depicted in FIG. 7, in that the Client may not want to process all events during each cycle. Instead, Events are sorted by priority so that the highest priority events are serviced first. If during Event Processing, a specified maximum amount of time is exceeded, then the Client does no process the lower priority Events but increases their priority instead. One the Event is generated, its priority returns to its original value. The net effect is to reduce load on the system. Lower priority Events would be delivered behind higher priority Events.

Up to this point, we have described two independent and long running processes within each Module of the Event Broker Client, one for sampling PID values (FIG. 5), and another for evaluating Triggered Event Expressions (FIG. 6). It is important to note that these two processes are intentionally independent so that they can be decoupled. In particular, on Devices capable of supporting multiple concurrent threads of execution, each process of each Module will run on an independent thread. There are some advantages to this approach in that a failure in one process does not impact the other; furthermore and more importantly, a delay in one process does not impact the other. The implication is that Expression parsing will never be encumbered by PID sampling.

Another embodiment of the Event Broker provides event queuing and transport in the absence of an Internet connection as depicted in FIG. 1 by the Remote Device 104 and the Proxy Remote Device With Radio 103 connected together by a 106, a connection typically but not limited to Bluetooth or a serial cable. When the Remote Device is connected to the Event Broker server via an Internet connection the underlying transport provides guaranteed once only message delivery, as discussed in commonly owned application Ser. Nos. 10/677,098 (Sep. 30, 2003), 11/486,467 (Jul. 14, 2006) and 11/715,589 (Mar. 8, 2007), the content of which is incorporated by reference. However, when the Remote Device 104 has no radio, the Event Broker Client must provide this. The Event Broker provides a “Reliable Queue Replication” strategy to ensure that all Events delivered by the Event Broker Client on Remote Device 104 are guaranteed to be delivered once and only once to the Event Broker Server without manual intervention from the user. This system is not only limited to Events, but any other data sent by the Event Broker Client and applies also to any data (e.g. Configuration) sent by the Event Broker Server.

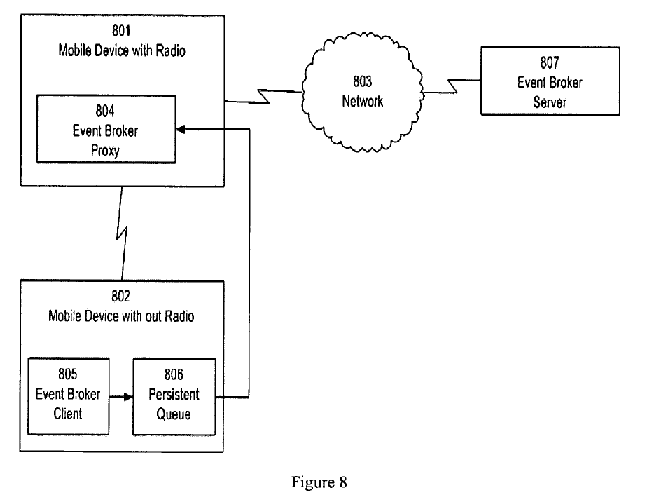

FIG. 8 shows the Event Broker Client 805 running on the Remote Device without Radio 802. The Client 805 writes its Events to the Persistent Queue 806, the details of which are discussed in more details in commonly owned, co-pending application Ser. Nos. 11/486,467 (Jul. 14, 2006) and 11/715,589 (Mar. 8, 2007), the content of which is incorporated by reference. The Event Broker Proxy 804 running on the Remote Device with Radio 801 reliably receives the Events in the Persistent Queue 806 over the Local Communication Channel 808, sends them over the Network 803 to the Event Broker Server 807 where then are removed from the Queue 806 upon success. The Local Communication Channel 808 is typically but not limited to Bluetooth or a serial cable connection between the two devices.

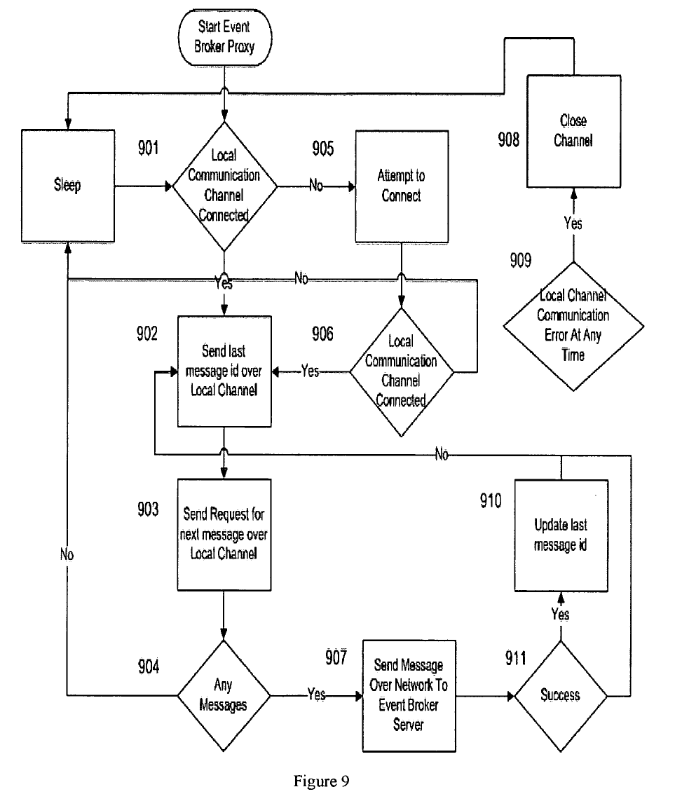

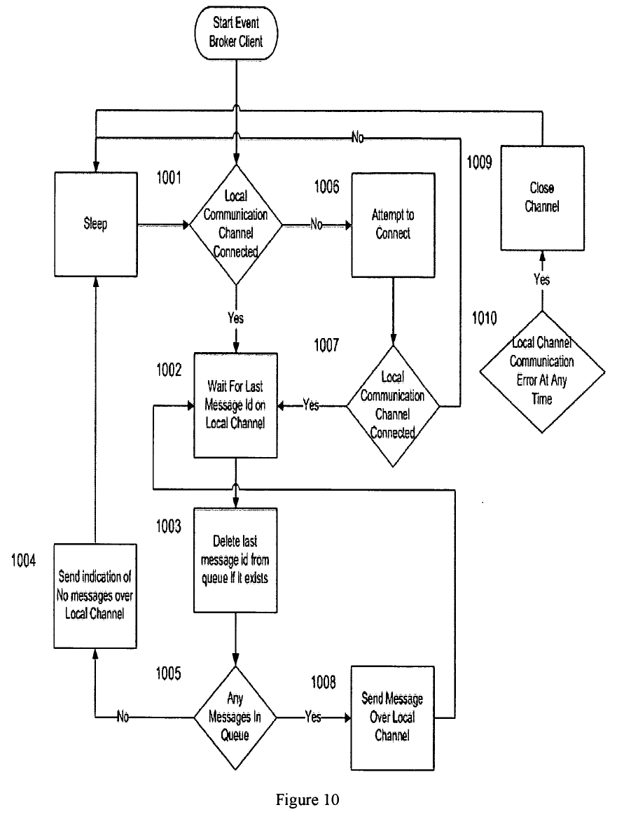

FIG. 9 illustrates the process the Event Broker Proxy follows to receive messages and FIG. 10 the process followed by the Event Broker Client providing the messages. These two processes work together to ensure once only, reliable, guaranteed delivery of an Event (or any other data) to the Event Broker Server. In FIG. 9, the process checks if a local communication channel is connected (901). If so, the process sends the last message identification over the local channel (902). Next, the process sends the request for the next message over the local channel (903). The process then checks for additional messages to be processed (904). From 904, if done, the process puts itself to sleep to conserver energy. From 904, if messages need to be processed, the process sends messages over the network to the Event Broker Server (907) and then checks for status (911). If successful, the process updates the last message ID (910) and loops back to 902 to send the last message ID over the local channel.

From 901, if the local communication channel is not connected, the process attempts to connect to the local communication channel (905) and then checks for a connection (906). If connected, the process performs 902 that sends the last message ID over the local channel and if not connect, the process goes to sleep.

In 909, if a local channel communication error occurred at any time, the process closes the channel (908) and goes to sleep.

Referring now to FIG. 10, an exemplary process run by the Event Broker Client is shown. The process checks for a connected local communication channel (1001). If connected, the process waits for the last message ID on the local channel (1002) and deletes the last message ID from the queue (1003). Next, the process checks for additional messages that need to be processed in the queue (1005). If the queue is empty, the process sends an indication of “No Message” over the local channel (1004). Alternatively, if more messages need processing, the message(s) are sent over the local channel (1008) and the process proceeds to 1002 to continue processing.

From 1001, if the local communication channel is not connected, the process attempts to connect (1006) and the checks the connection (1007). If connected, the process proceeds to 1002 to wait for the last message ID on the local channel. If not connected, the process goes to sleep to conserve energy.

In 1010, if a local channel communication error occurred at any time, the process closes the channel (1009) and goes to sleep.

In one implementation, the Mobile Communications Server is the Kona Ware Server, available from Kona Ware of Menlo Park, Calif. The Kona Ware Server manages the communication between the remote applications and backend enterprise applications. It supports asynchronous messaging, message encryption, guaranteed once and-only-once message delivery and message prioritization over multiple communication channels. All messages to and from devices can be logged for auditing purposes. The system is highly scalable and can be configured to handle a large set of message queues that can reach tens of thousands of remote devices. The Kona Ware Console is a Web-based system administration tool for the deployment and management of remote applications.

The Kona Ware Shuttle is the implementation of the Messaging Subsystem on remote devices. It contains libraries that implement the Message Queuing System identical to those found in the Kona Ware Server. A Kona Ware Shuttle using the File Message Store is provided on devices that support .NET, .NET Compact Framework or Java operating environments. A Kona Ware Shuttle using the RMS Message Store is provided in J2ME environments. As a result, remote applications built with Kona Ware are extensible across a continuum of remote devices from smart phones to laptops. These applications are not browser-based or thin-client interfaces, but rather true multi-threaded applications with transparent offline and online functionality. The application interface and navigation can be optimized for each specific device type in order to provide the greatest usability and performance.

The Kona Ware Shuttle ensures seamless off-line and on-line functionality for remote applications by facilitating automatic network connection detection. All messages are queued locally and automatically sent wirelessly when network connectivity is available. This asynchronous delivery system ensures efficient transmission of data and a guarantee of “always there” data using two-way push/pull transmissions. In addition, the Kona Ware Shuttle has built in mechanisms that detect message, device, and network settings so that performance is optimized depending on network availability.

While this invention has been described with reference to specific embodiments, it is not necessarily limited thereto. Accordingly, the appended claims should be construed to encompass not only those forms and embodiments of the invention specifically described above, but to such other forms and embodiments, as may be devised by those skilled in the art without departing from its true spirit and scope.

What is claimed is:

1. A method for monitoring a remote object, comprising:
a. providing a configuration file to a remote client to direct the remote client to capture events of interest specified by one or more rules;
b. wirelessly sending events of interest captured by the remote client to a server; and
c. generating a report on the events of interest.

2. The method of claim 1, wherein the remote client comprises one of: a cell phone, a personal digital assistant or a black box installed in a vehicle.

3. The method of claim 1, wherein the event of interest comprises one of vehicle speed, vehicle performance data, vehicle diagnostic data, vehicle maintenance data.

4. The method of claim 1, comprising generating and publishing the configuration file to all remote clients.

5. The method of claim 1, comprising downloading one or more dynamically pluggable modules loaded at startup time and specified by the configuration file.

6. The method of claim 1, comprising allowing a set of modules on a remote client to be changed without having to have physical access to the remote client.

7. The method of claim 1, comprising specifying a triggered event in the configuration file.

8. The method of claim 7, wherein the triggered event comprises an expression stored in postfix form indicating one or more conditions in which the event will be generated by the remote client.

9. The method of claim 7, wherein the triggered event comprises a reporting rate indicating a maximum rate for event transmission.

10. The method of claim 7, wherein the triggered event comprises a sampling rate or a sampling window.

11. A system to monitoring a remote object, comprising:
a. a remote client to receive a configuration file directing the remote client to capture events of interest specified by one or more rules;
b. a wireless network to communicate events of interest captured by the remote client; and
c. a server coupled to the remote client over the wireless network, the server receiving events of interest from the remote client and generating a report on the events of interest.

12. The system of claim 11, wherein the remote client comprises one of: a cell phone, a personal digital assistant or a black box installed in a vehicle.

13. The system of claim 11, wherein the event of interest comprises one of vehicle speed, vehicle performance data, vehicle diagnostic data, vehicle maintenance data.

14. The system of claim 1 system, wherein the server generates and publishes the configuration file to all remote clients.

15. The system of claim 11, wherein the remote client download one or more dynamically pluggable modules loaded at startup time and specified by the configuration file.

16. The system of claim 11, comprising a set of modules on a remote client to be changed without physical access to the remote client.

17. The system of claim 11, wherein a triggered event is specified in the configuration file.

18. The system of claim 17, wherein the triggered event comprises an expression stored in postfix form indicating one or more conditions in which the event will be generated by the remote client.

19. The system of claim 17, wherein the triggered event comprises a reporting rate indicating a maximum rate for event transmission.

20. The system of claim 17, wherein the triggered event comprises a sampling rate or a sampling window.

21. The system of claim 11, wherein the client performs dynamic threshold tuning to prevent overloading the remote client.

22. The system of claim 11, wherein the client eliminates rarely reported events from being generated.

23. The system of claim 11, wherein the client precompiles a process identification (PID) tolerance so save computing only when PID value reaches a value that will trigger an event.

24. The system of claim 11, wherein the client performs event priority and aging to allow high priority events to be sent first while ensuring that lower priority events will eventually get sent and not stuck forever.

25. The system of claim 11, wherein the client performs PID sampling and expression evaluation using separate threads to prevent a delay in one thread from impacting the other.

26. The system of claim 11, comprising an Event Broker proxy allowing a PID sampling device to use the network of another device to transmit events to the server.

27. The system of claim 11, wherein the remote client comprises one of: a personal digital assistant, a smart phone, a cellular telephone, a driving assistance device, a global positioning system (GPS) device, a fixed mounted monitoring device.
